(19) United States
(12) Patent Application Publication
(10) Pub. No.: US 2007/0026986 A1
(43) Pub. Date: Feb. 1, 2007

(54) Tensioning device

(75) Inventor: Howard F. Walker, Toppenish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Moxee Innovations Corporation, Toppenish, WA (US)

(21) Appl. No.: 11/454,606

(22) Filed: Jun. 16, 2006

Related U.S. Application Data
(60) Provisional application No. 60/691,005, filed on Jun. 16, 2005.

(51) Int. Cl. F16H 7/12

(52) U.S. Cl. 474/134

(57) ABSTRACT

A tensioning device (10) is provided. The tensioning device (10) includes a housing (15) and a first pulley (16) removably coupled to the housing for selective positioning of the first pulley (16) relative to a second pulley (16) to adjust tension associated with a drive element (18) extending between the first and second pulleys (16).

### CROSS-REFERENCE TO RELATED APPLICATION

This application claims the benefit of Provisional Application No. 60/691,005, filed Jun. 16, 2005, the disclosure of which is hereby expressly incorporated by reference.

### BACKGROUND

A conventional drive system often includes a flexible drive element, or drive belt that interconnects at least two drive elements, such as drive sheaves. The drive system requires maintenance to ensure satisfactory performance and durability of the belt. Correct operating tension is a factor in the satisfactory performance and life of any drive belt. In fact, drive belts wear at an increased rate if they are allowed to run with insufficient tension. As drive belts wear they seat themselves deeper in the sheave grooves. This seating, along with belt stretch, lessens the initial tension. The result is vibration, slippage, and loss in horsepower capacity unless some form of take-up is used to restore and maintain the original tension. On the other hand, too much tension in the belt can lead to excessive belt and bearing wear.

One way to adjust the belt tension is through the use of a tensioning device. A tensioning device may be used to bias one or both of the drive belt runs inwardly toward the other run at a point intermediate the drive sheaves. The tensioning device may instead bias one or both of the drive belt runs outwardly away from the other run at a point intermediate the drive sheaves. Using a tensioning device to constantly provide a suitable amount of tension to the drive belt increases the life of the drive system.

### SUMMARY

A tensioning device is provided. The tensioning device includes a housing and a first pulley removably coupled to the housing for selective positioning of the first pulley relative to a second pulley to adjust tension associated with a drive element extending between the first and second pulleys.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an isometric view of a tensioning device coupled to a drive system; and

FIG. 2 is a partially exploded isometric view of the tensioning device of FIG. 1 coupled to a drive system.

### DETAILED DESCRIPTION

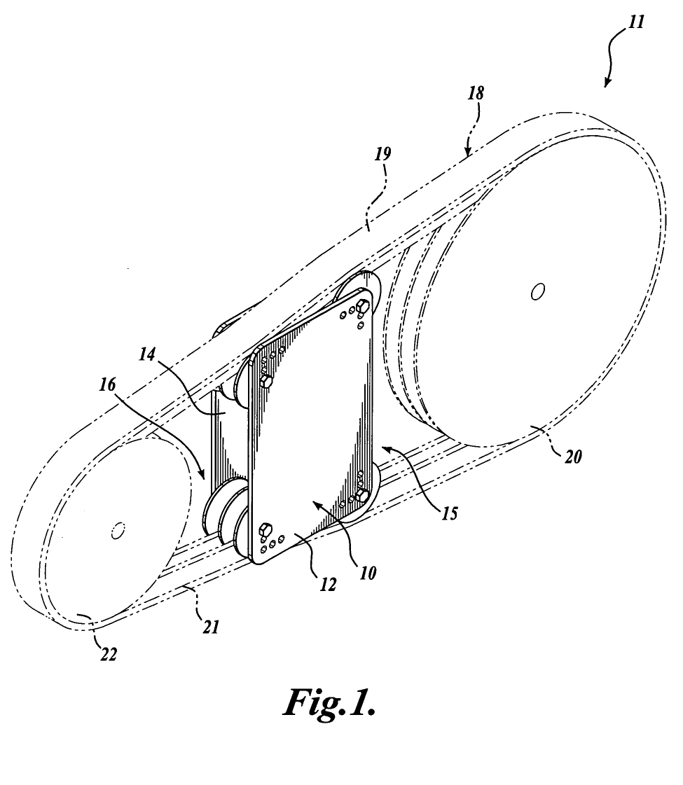

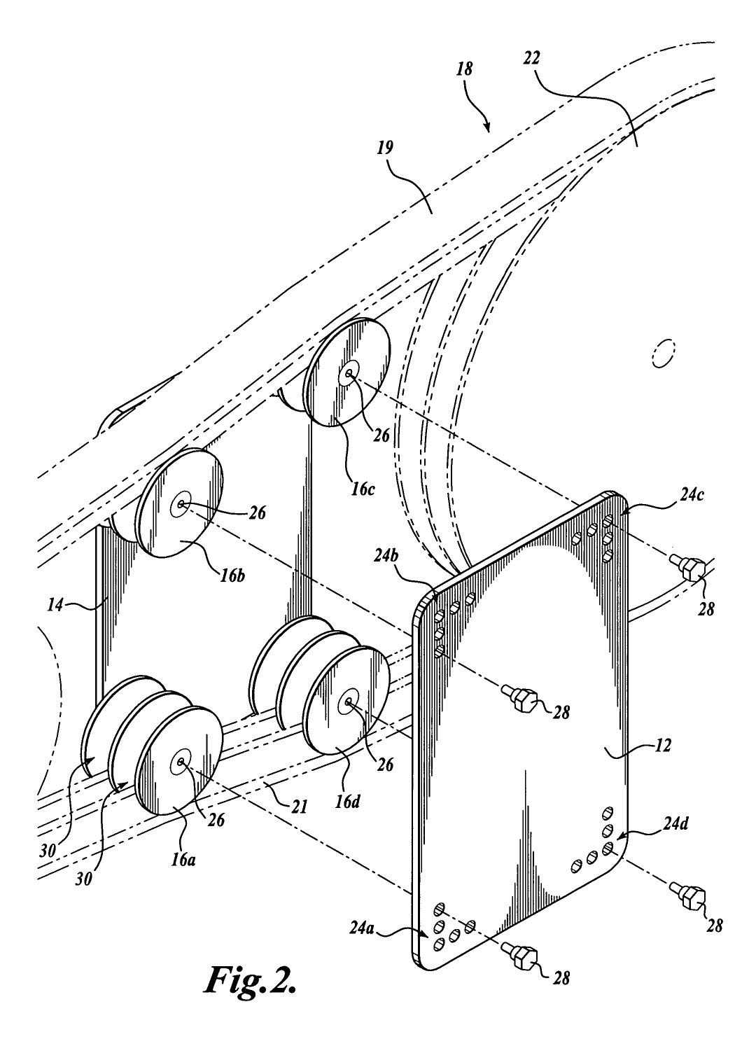

FIGS. 1 and 2 illustrate a preferred embodiment of a tensioning device 10 constructed in accordance with the present disclosure. Referring to FIG. 1, the tensioning device 10 is used in connection with a conventional drive system 11. Although the tensioning device 10 may be used with any conventional drive system, the illustrated drive system 11 includes a driving element 20 and a driven element 22 interconnected by a flexible drive element 18. The flexible drive element 18 may be any standard belt, such as a V-belt, a flat drive belt, a grooved belt, etc.

The flexible drive element 18 is preferably a V-belt having two ribs formed on the interior of the belt. The drive element 18 is formed as a complete loop and passes around the first driving element 20 and the second driving element 22 to provide continuous driving force. The drive element 18 includes an upper run 19 extending between the upper sides of the elements 20 and 22, and a lower run 21 extending between the lower sides of the elements 20 and 22.

The driving element 20 and driven element 22 may be any suitable element such as a pulley, sheave, etc. Preferably, the driving and driven elements 20 and 22 are sheaves having two grooves formed along the exterior perimeter thereof for receiving the ribs of the drive element 18. The drive element or drive sheave 20 drives the drive element 18, and the drive element 18 drives the driven element or driven sheave 22.

Referring to FIG. 2, the tensioning device 10 includes a housing 15 having a first end plate 12 and a second end plate 14 and a gap defined therebetween. The first and second end plates 12 and 14 preferably have a substantially similar rectangular shape; however, other shapes are also within the scope of this disclosure. A plurality of apertures 24 are formed in each corner of the first and second end plates 12 and 14, wherein a first group of apertures 24A are formed in a first corner, a second group of apertures 24B are formed in a second corner, a third group of apertures 24C are formed in a third corner, and a fourth group of apertures 24D are formed in a fourth corner. Preferably, the apertures 24 formed in each respective corner of the first end plate 12 substantially mirror the apertures 24 formed in each respective corner of the second end plate 14.

A plurality of pulleys 16 are rotatably mounted between the first and second end plates 12 and 14 of the housing 15. Preferably, four standard V-belt pulleys 16A, 16B, 16C, and 16D are mounted within the housing 15, wherein each pulley includes two pulley grooves 30 formed around its exterior circular perimeter. Each V-belt pulley 16A, 16B, 16C, and 16D includes a central through-bore 26 that houses a bushing or bearing assembly (not shown). V-belt pulley 16A is rotatably fastened between the first and second end plates 12 and 14 by passing a suitable fastener, such as a screw, shaft, bolt, etc., through one of the apertures 24A in the first end plate 12, through the central bore 26 of pulley 16A, and through one of the apertures 24A in the second end plate 14. The other V-belt pulleys 16B, 16C, and 16D are rotatably fastened between the first and second end plates 12 and 14 in a similar fashion. The bushing or bearing assembly permits rotation of each V-belt pulley 16A, 16B, 16C, and 16D about its center axis defined by the central through-bore 26.

The cross-section of the pulley grooves 30 substantially conform in shape and size to the cross-section of the ribs of the drive element 18 so that the V-belt pulleys 16A, 16B, 16C, and 16D are engageable with the drive element 18. The tensioning device 10 can be located between the upper and lower runs 19 and 21 on the drive element 18 intermediate the sheaves 20 and 22. As an example, the tensioning device can be positioned such that pulleys 16B and 16C engage the ribs on the upper run 19 and pulleys 16A and 16D engage the ribs on the lower run 21. The tensioning device 10 pushes the upper and lower runs 19 and 21 of the drive element 18 away from each other. In this manner, the slack is removed from the drive element 18, thereby decreasing belt wear and substantially reducing the possibility that the belt 18 will come off one of the sheaves 20 or 22.

The tensioning device 10 is free floating in that it is held in position solely by the tension in the upper and lower runs 19 and 21 of the drive element 18. In this manner, the tensioning device 10 dampens shock and vibration rather than adding to the vibration generated from the sheaves 20 and 22. Moreover, the free floating design of the tensioning device 10 allows for easy installation, adjustment, and removal.

The tensioning device 10 may be adjusted while remaining positioned on the drive element 18 to increase or decrease the tension of the drive element 18. To adjust the tension, the V-belt pulleys 16A-16D may be repositioned within the housing 15 to either increase or decrease the spacing between the pulleys 16A-16D disposed within the tensioning device 10. As shown in FIGS. 1 and 2, each corner of the first and second end plates 12 and 14 include a vertical row of apertures 24. The pulley position may be adjusted by passing the fastener 28 through an aperture 24 either closer to or further away from the corner of the end plates 12 and 14. When the pulleys 16A-16D are repositioned closer to the corner of the end plates 12 and 14, the spacing between the pulleys is increased. The tensioning device 10 therefore pushes the upper and lower runs 19 and 21 further away from each other, and the tension in the drive element 18 is increased. When the pulleys 16A-16D are repositioned further away from the corner of the end plates 12 and 14, the spacing between the pulleys is decreased. As such, the tensioning device 10 does not exert as much force against the upper and lower runs 19 and 21, and the tension in the drive element 18 is decreased.

The pulley positions may also be horizontally repositioned within the housing 15 to either increase or decrease the width between the pulleys. The width between the pulleys may need adjustment to ensure that the tensioning device 10 is properly positioned between the sheaves 20 and 22. As shown in FIGS. 1 and 2, each corner of the first and second end plates 12 and 14 includes a horizontal row of apertures 24. The pulley position may be adjusted by passing the fastener 28 through an aperture 24 either closer to or further away from the corner of the end plates 12 and 14.

By only adjusting one pulley 16 at a time, the tensioning device 10 does not need to be removed from the drive element 18. The pulleys 16A-16D can be adjusted as needed on the tensioning device 10 so as to constantly apply a suitable tensioning force to the drive element 18.

It should be appreciated that the tensioning device 10 can also be positioned such that pulleys 16B and 16C engage the outer surface of the upper run 19 and pulleys 16A and 16D engage the outer surface of the lower run 21. For instance, if the drive system 11 included a flexible drive element 18 that had the same inner and outer surface shape, such as a flat drive belt, the drive element 18 could be received within flat-grooved pulleys 20, 22, 16A, 16B, 16C, and 16D on either side of the belt. The tensioning device 10 would again be free floating in that it would be held in position solely by the tension in the upper and lower runs 19 and 21 of the drive element 18. Moreover, the tensioning device 10 would push the upper and lower runs 19 and 21 inwardly towards each other to remove the slack in the drive element 18. This arrangement maintains a greater surface area of the drive belt in contact with the outer surface of the sheaves 20 and 22 at any given time.

The tensioning device 10 may be similarly adjusted while remaining positioned on the outer surface of the drive element 18 to increase or decrease the tension of the drive element 18. To adjust the tension, the V-belt pulleys 16A-16D may be vertically repositioned within the housing 15 to either increase or decrease the distance between pulleys 16A and 16B and between pulleys 16C and 16D. The pulley position may be adjusted by passing the fastener 28 through an aperture 24 either closer to or further away from the corner of the end plates 12 and 14. When the pulleys 16A-16D are repositioned further away from the corner of the end plates 12 and 14, the distance between pulleys 16A and 16B and between pulleys 16C and 16D is decreased and, therefore, the tension in the drive element 18 is increased. When the pulleys 16A-16D are repositioned closer to the corner of the end plates 12 and 14, the distance between pulleys 16A and 16B and between pulleys 16C and 16D is increased and, therefore, the tension in the drive element 18 is decreased. The pulley positions may be horizontally repositioned within the housing 15 to either increase or decrease the width between the pulleys, as described above.

While illustrative embodiments have been illustrated and described, it will be appreciated that various changes can be made therein without departing from the spirit and scope of the invention.

The embodiments of the invention in which an exclusive property or privilege is claimed are defined as follows:

1. A tensioning device engageable with a drive element of a drive system, the tensioning device comprising:
(a) a housing; and
(b) a first pulley removably coupled to the housing for selective positioning of the first pulley relative to a second pulley to adjust tension associated with a drive element extending between the first and second pulleys.

2. The tensioning device of claim 1, wherein the second pulley is removably coupled to the housing to adjust the tension associated with the drive element.

3. The tensioning device of claim 2, further comprising a third pulley in communication with the drive element and removably coupled to the housing to adjust the tension associated with the drive element.

4. The tensioning device of claim 3, further comprising a fourth pulley in communication with the drive element and removably coupled to the housing to adjust the tension associated with the drive element.

5. The tensioning device of claim 4, wherein the housing includes a plurality of apertures to permit removable coupling of the pulleys.

6. A tensioning device, comprising:
(a) a housing having a first set of a plurality of apertures;
(b) a first pulley adjustably coupled to at least one of the plurality of apertures for selective positioning of the first pulley relative to a second pulley to adjust tension associated with a drive member extending between the first and second pulleys.

7. The tensioning device of claim 6, wherein the second pulley is adjustably coupled to at least one aperture from a second set of a plurality of apertures to adjust tension associated with the drive member.

8. The tensioning device of claim 7, further comprising a third pulley in communication with the drive member and adjustably coupled to at least one aperture from a third set of a plurality of apertures to adjust tension associated with the drive member.

9. The tensioning device of claim 8, further comprising a fourth pulley in communication with the drive member and adjustably coupled to at least one aperture from a fourth set of a plurality of apertures to adjust tension associated with the drive member.

10. The tensioning device of claim 6, further comprising a third pulley in communication with the drive member and adjustably coupled to at least one aperture from a second set of a plurality of apertures to adjust tension associated with the drive member.

11. A tensioning device, comprising:
(a) a housing including first and second end plates, each of the first and second end plates having a first set of a plurality of apertures;
(b) a first pulley coupled to at least one of the plurality of apertures;
(c) a second pulley coupled to the housing; and
(d) a drive member extending between the first and second pulleys, wherein the first pulley is repositionable within the first set of a plurality of apertures to move the first pulley relative to the second pulley to adjust tension associated with the drive member.

12. The tensioning device of claim 11, wherein the second pulley is removably coupled to the housing by a second set of a plurality of apertures.

13. The tensioning device of claim 12, further comprising a third pulley removably coupled to the housing by a third set of a plurality of apertures.

14. The tensioning device of claim 13, further comprising a fourth pulley removably coupled to the housing by a fourth set of a plurality of apertures.
